(19) United States
(12) Patent Application Publication
(10) Pub. No.: US 2015/0183318 A1
(43) Pub. Date: Jul. 2, 2015

(54) Drivetrain For Independent Suspension System

(71) Applicant: Ronald Scott Bandy, San Pablo, CA (US)

(72) Inventor: Ronald Scott Bandy, San Pablo, CA (US)

(21) Appl. No.: 14/087,552

(22) Filed: Dec. 26, 2013

(51) Int. Cl. B60K 17/22; B60G 7/02; B60K 5/02; B60K 17/344; B60K 17/16

(52) U.S. Cl. CPC B60K 17/22; B60K 17/344; B60K 17/165; B60K 5/02; B60G 7/02

(57) ABSTRACT

Disclosed herein is a novel drivetrain concept developed for the four wheel drive vehicle. This drivetrain is specifically designed to operate in conjunction with the extreme-travel independent suspension system, an independent suspension system that is disclosed in the U.S. patent application, Ser. No. 14/059,062; whereby, the criterion of this drivetrain design is dictated by the unique suspension configuration of the leading links. Inspired by Ford's twin-traction beam front suspension system, a key component of the drivetrain concept is a unique frame-mounted reverse power coupler, other components including a differential-mounted offset power coupler and differential housing assemblies. The drivetrain concept embraces the suspension system's fundamental properties-handling quality like an independent suspension system and travel and articulation capabilities potentially superior to that of a solid axle—by securing all weight-bearing components directly or indirectly to the frame and utilizing long axle shafts whose joints coincide with those of the leading links.

### CROSS-REFERENCE TO RELATED APPLICATIONS

This application represents a novel drivetrain specifically designed to operate in conjunction with the extreme-travel Independent suspension system. This novel suspension system is covered in U.S. patent application Ser. No. 14/059,062.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Four wheel drive (4WD) vehicles possessing independent suspension systems employ a drivetrain whose differential housings are mounted to the frame, the lone exception being the twin-traction beam front suspension system (TTB) developed by the Ford Motor Company. The differential housing is a component of the differential housing assembly whereby other components of the assembly include the bracketry that attaches the differential housing to the frame. Dimensionally, the side of the bracketry refers to the side of the differential housing assembly; for purposes of discussion, the side of the differential housing assembly is referred to as the outer edge of the differential housing assembly. The differential housing assembly is secured to the frame in-between the frame sides, along the center line of the vehicle; and, the control arms in the independent suspension system are attached to the outer edge of the differential housing assembly. The bracketry, by virtue of its bulk, acts to move the outer edge of the differential housing assembly away from the center line and towards the frame sides, thereby also moving the mounting point for the control arms away from the center line and towards the frame sides. This mounting arrangement produces a suspension configuration in which the length of the control arms is less than one-half the length of the vehicle's track width. Given that suspension travel and articulation are directly related to the length of the control arms, builders of customized 4WD vehicles with independent suspension systems maximize the length of the control arms with a two-step approach: first, by positioning the differential housing in the center of the assembly and therefore the center of the vehicle; and second, by minimizing the overall width of both the differential housing and the assembly. Such an approach is very effective, yet requires specialized drivetrain components not ordinarily utilized in production 4WD vehicles.

When measured against a comparable solid axle, such an approach is inherently limited in articulation capability because the length of the control arms in a 4WD independent suspension system will always be less than one-half the length of the vehicle's track width. This length restriction is a consequence of the control arms being attached to the outer edge of the differential housing assembly rather than the center point of the vehicle. Given the improved handling of the independent suspension system compared to a solid axle based suspension system, then an ideal suspension system for a 4WD vehicle is one that possesses the handling of the independent suspension system and the travel and articulation of the solid axle.

This ideal suspension system has been addressed in the patent application Ser. No. 14/059,062 cited above. In the above cited patent application, an independent suspension design concept is proposed whereby the length of the control arms is able to match that of the vehicle's track width, thereby yielding the handling like an independent suspension system and the travel and articulation potentially superior to a solid axle. Adapting this novel suspension design concept to a 4WD vehicle requires an equally novel drivetrain that can transmit power from the transmission to the wheels. Disclosed herein is a drivetrain concept specifically designed to operate in conjunction with the independent suspension system disclosed in the patent application cited above.

### Suspension Configuration of Patent Application Ser. No. 14/059,062

To function properly with the suspension system disclosed in the patent application cited above, the drivetrain must be congruent with the suspension configuration. For purposes of understanding, consider the following suspension configuration taken from the aforementioned patent application: “This configuration of four links per wheel refers to a type of double wishbone suspension configuration and is comprised of a pair of upper and lower leading links and a pair of upper and lower trailing links. Beginning with, say, the front driver wheel: The pair of upper and lower leading links is oriented laterally across the vehicle's frame from the front passenger frame side to the front driver wheel, the front passenger frame side being proximate the front passenger wheel; and the pair of upper and lower trailing links is oriented longitudinally and forwardly from the mid-point of the driver frame side to the front driver wheel. The one ends of the upper and lower leading links are affixed to flexible joints, the flexible joints being pivotally attached to mounting brackets, the mounting brackets being vertically affixed to the top and bottom of the front passenger frame side proximate the front passenger wheel, respectively, each mounting bracket projecting inward towards the engine bay; and the one ends of the upper and lower trailing links are affixed to flexible joints, the flexible joints being pivotally attached to mounting brackets, the mounting brackets being vertically affixed to the top and bottom of the driver frame side near its mid-point, respectively, each mounting bracket projecting outward away from the engine bay. The other ends of the upper leading and trailing links are attached to the upper apex bracket while the other ends of the lower leading and trailing links are attached to the lower apex bracket. The upper and lower apex brackets each contain a ball joint, the ball joints being pivotally attached to the top and bottom of the driver steering knuckle, respectively. By repeating the above design concept with the front passenger wheel, the suspension system for the front of the vehicle can be described.”

### Drivetrain Design Criterion

In order to successfully supply power to the wheels of a vehicle with independent suspension, the axle shaft must move in concert with the control arms during suspension travel. Typically, the axle shaft transmits power from the differential housing to a wheel by being attached on one end to the differential housing and on the other end to the wheel, specifically the wheel hub. One way to accomplish this task is to ensure that the properties (length, angle, location) of the axle shaft match those of the control arms; which in turn, can be achieved by positioning the ends of the axle shaft in the same locations as are the ends of the control arms. For a double wishbone suspension system, this means positioning one and the other ends of the axle shaft in the same locations as are the frame and wheel ends of the control arms, respectively, whereby the control arms refer to upper and lower control arms. Given that the ends of the axle shaft and upper and lower control arms are affixed to flexible joints—U-joints or constant velocity-(CV-) joints for one and the other ends of the axle shaft, and bushings, spherical rod ends, etc. for the frame ends of the upper and lower control arms and ball joint brackets for the wheel ends of the upper and lower control arms, then this positioning technique refers to the U or CV-joints on one and the other ends of the axle shaft occupying the same respective lines that pass through the flexible joints and ball joint brackets of the upper and lower control arms, respectively, throughout suspension travel. The ball joint brackets of the upper and lower control arms are attached to the top and bottom of the knuckle, respectively. Or put simply, the joints of the axle shaft are coincident with the joints of the control arms throughout suspension travel. Once the axle shaft is positioned correctly, the U or CV-joints on one and the other ends of the axle shaft are attached to the differential housing and wheel hub, respectively. The wheel hub has one and the other sides such that one side is rotatably attached to the knuckle and the other side is attached to the wheel.

In the case of a 4WD vehicle with the double wishbone suspension system, the frame ends of the upper and lower control arms are attached to the outer edge of the differential housing assembly and the ball joint brackets of the upper and lower control arms are attached to the top and bottom of the knuckle, respectively. The attachment between the ball joint bracket and knuckle is made with a ball joint. Therefore the coincident joint technique can be satisfied with a three-step procedure: first, employ an axle shaft whose length positions the U or CV-joints on one and the other ends of the axle shaft on the lines passing through the flexible joints of the upper and lower control arms and ball joints attached to the top and bottom of the knuckle, respectively; second, attach the U or CV-joint on one end of the axle shaft to the differential housing at the outer edge of the differential housing assembly; and third, attach the U or CV-joint on the other end of the axle shaft to the wheel hub. This way, the flexible joints of the upper and lower control arms coincide with the U or CV-joint on the one end of the axle shaft, and the ball joints attached to the top and bottom of the knuckle coincide with the U or CV-joint on the other end of the axle shaft throughout suspension travel. This coincident joint process ensures that the U or CV-joints on one and the other ends of the axle shaft can be attached to the differential housing and wheel hub, respectively. Given the unique configuration of the suspension system disclosed in the aforementioned patent application, then the three-step procedure mentioned above must be modified in order to apply it to the present invention. Addressing the first and third steps is a simple matter of constructing an axle shaft of the proper length and attaching the other end of the axle shaft to the wheel hub, therefore this matter is assumed to be satisfied in the present invention. However, addressing the second step is more challenging because the frame ends of the upper and lower leading links are attached to the opposite frame side, whereby the opposite frame side refers to the frame side opposite the one next to the wheel that the wheel ends of the upper and lower leading links are attached to. Thus, in order for the frame end joints of the upper and lower leading links to coincide with the joint on one end of the axle shaft, then one end of the axle shaft must be attached to the opposite frame side in the same location as are the frame ends of the upper and lower leading links. Specifically, given that the aforementioned suspension system represents a pair of upper and lower leading links being oriented laterally across the vehicle's frame from one frame side to the other front wheel such that the one ends of the pair of upper and lower leading links are attached to the one frame side, proximate one front wheel, while the other ends of the pair of upper and lower leading links are attached to the other front wheel, then in principle an axle shaft could transmit power to the other front wheel if one end of the axle shaft is attached to the one frame side in the same location as are the one ends of the pair of upper and lower leading links while the other end of the axle shaft is attached to the other front wheel, specifically, the other front wheel hub. Therefore, the design criterion for the present invention is a drivetrain that is able to transmit power from the one frame side in the same location as the one ends of the pair of upper and lower leading links.

Representing the earliest example of a 4WD independent front suspension system, Ford's TTB, a powered version of their twin I-beam front suspension system (TIB), delivers power to the front wheels by incorporating the front differential housing into one of the two beams in the TIB. Of particular interest, the TTB offers a true long-travel independent suspension design and utilizes a long axle shaft to transmit power from the differential housing to one of the front wheels, the long axle shaft having U-joints at both ends like those used in 4WD vehicles with double wishbone types of suspension systems. In principle, if the differential housing in the TTB was moved from the one beam to the one frame side, then one end of the long axle shaft would be located at the same spot on the one frame side as are the one ends of the pair of upper and lower leading links. By constructing a type of gearbox that is functionally analogous to the differential housing in the TTB and then relocating the gearbox from the one beam to the one frame side, then in principle the TTB can be re-designed to yield a drivetrain that is capable of transmitting power from the same location on the one frame side as are the one ends of the pair of upper and lower leading links. As such, the redesigned TTB serves as the inspiration for a drivetrain that satisfies the design criterion of the present invention.

### Reverse Power Coupler

Consider a drivetrain design concept that is founded upon a unique type of gearbox derived from a hub reduction gearbox. The hub reduction gearbox, also known as a double reduction hub, is a key component of a well-known solid axle known as a portal axle. The hub reduction gearbox can be viewed as an oval-rectangular shaped housing whose internal components include two or more gear sprockets, an input shaft, and an output shaft. The input shaft protrudes out of the upper portion of one side of the housing and the output shaft protrudes out of the lower portion of the opposite side of the housing. In the portal axle, the hub reduction gearbox is attached to the end of the axle tube where the input shaft is located and to the wheel where the output shaft is located. Power is transmitted from the differential housing to one side of the hub reduction gearbox via the input shaft and from the opposite side of the hub reduction gearbox to the wheel via the output shaft. The predominant characteristic of the hub reduction gearbox is that the input shaft is several inches above the output shaft. This several inch difference in height between the axle tube and wheel effectively increases the ground clearance of an otherwise ordinary solid axle. In the present invention, the hub reduction gearbox is re-designed to yield a unique gearbox henceforth called a reverse power coupler.

The reverse power coupler possesses internal components that are similar to those of the hub reduction gearbox such as several gear sprockets and an input and output shafts, but the input and output shafts both protrude from the same side of the gearbox. This way, the reverse power coupler possesses the ability to accept power via the input shaft and then deliver power via the output shaft, and in so doing, possesses the capability of transmitting power from whatever spot the reverse power coupler is located at. In the case of the present invention, the reverse power coupler is uniquely incorporated into each frame side in the same location as that for the mounting brackets for the one ends of each pair of upper and lower leading links. The mounting brackets are affixed to the outer surface of the gearbox and serve as connection locations for the one ends of each pair of upper and lower leading links. The external components of the reverse power coupler are positioned on the same side in a vertical orientation such that in descending order the input shaft is the top component, followed by the upper leading link mounting bracket, then the output shaft, and then the lower leading link mounting bracket is the bottom component. The reverse power coupler behaves like a hub reduction gearbox, thereby acting to transmit power from the differential housing to the wheel. Specifically, power is now able to be transmitted from the differential housing to the input shaft of the reverse power coupler with a short axle shaft, then from the output shaft of the reverse power coupler to a wheel with a long axle shaft. Of critical importance-the vertical orientation of the input and output shafts and upper and lower leading link mounting brackets replicates the manner in which the upper and lower leading link mounting brackets are vertically affixed to the frame sides in the suspension system disclosed in the aforementioned patent application, thereby when combined with a long axle shaft of proper length, enabling the U or CV-joints on one and the other ends of the long axle shaft to be coincident with the flexible joints on the one ends of the pair of upper and lower leading links and ball joints attached to the top and bottom of the knuckle, respectively, throughout suspension travel. This coincident joint process allows the U or CV-joints on one and the other ends of the long axle shaft to be attached to the output shaft of the reverse power coupler and wheel hub, respectively. The wheel hub has one and the other sides such that one side is rotatably attached to the knuckle and the other side is attached to the wheel. By transmitting power from the same location as that for the mounting brackets for the one ends of each pair of upper and lower leading links, the reverse power coupler represents the vital component in a drivetrain that now possesses the capability of operating in conjunction with the suspension design concept disclosed in the aforementioned patent application.

### Differential Housing Assembly

Included in the drivetrain design concept is a differential housing assembly. This assembly consists of a differential housing, mounting brackets, and U or CV-joint flanges. The differential housing is similar to that used by Ford's TTB and by manufacturers of 4WD vehicles with independent front suspension systems. Using techniques that are analogous to those employed by builders of customized 4WD vehicles with independent front suspension systems, the construction of this differential housing assembly involves three steps: one, a solid axle comprised of a differential housing and axle tubes is broken down such that the axle tubes are removed from the sides of the differential housing and discarded; two, the sides of the differential housing are machined and attached to U or CV-joint flanges. These flanges serve as connection locations for the short axle shafts that facilitate the transmission of power from the differential housing to the reverse power couplers; and three, mounting brackets are attached to the sides of the differential housing. In the present invention, each mounting bracket consists of a semi-circular steel plate and a pair of steel strips. A hole is machined into the center of each plate, and shaped in such a manner that the plate can be passed over the U or CV-joint flange and attached directly to the side of the differential housing.

Each strip in a pair of strips has one and the other ends, whereby the one ends are attached perpendicularly to their respective outer edges of the flat section of the plate and the other ends are attached to their respective sides of a frame side aperture, the aperture being an open space fabricated into the frame side. Each pair of strips is oriented in such a manner that: one, the differential housing is positioned in-between the respective reverse power couplers and on a longitudinal line passing through the center of the vehicle; two, the U or CV-joint flanges are positioned on a line passing through the respective wheels; and three, an open space is created in-between the strips such that the underlying upper and lower leading links and long axle shaft can travel upward in-between the strips and into the aperture when the suspension compresses.

Each mounting bracket has plate and strip ends, the plate end being attached to the driver or passenger side of the differential housing and the strip ends being attached to a driver or passenger frame side, respectively. As such, the front or rear differential housing is secured to the frame with a pair of driver and passenger mounting brackets. The combination of the front or rear differential housing and attached pair of driver and passenger mounting brackets refers to the front or rear differential housing assembly, the front or rear differential housing assembly serving as a single structural unit that acts to strengthen and solidify the front or rear framework thereby providing additional structure to the frame. The front or rear framework contains the driver and passenger reverse power couplers whereby the driver and passenger reverse power couplers represent the surfaces to which are affixed the mounting brackets that attach the upper and lower leading links to the front or rear end of the frame, respectively.

### Powered Extreme-Travel Independent Suspension System

Consider the following integration of the suspension system disclosed in the aforementioned patent application with the drivetrain design concept discussed above: (1) a reverse power coupler is incorporated into each frame side in the same location as are the frame side mounting brackets for the one ends of each link in the pair of upper and lower leading links as described in the aforementioned suspension system. Each reverse power coupler is located within the frame side such that the external components are positioned on the same side in a vertical orientation in the descending order: the input shaft is the top component, followed by the upper leading link mounting bracket, then the output shaft, and then the lower leading link mounting bracket is the bottom component, with each shaft and mounting bracket projecting inward towards the engine bay, (2) beginning with, say, the front driver wheel: The pair of upper and lower leading links is oriented laterally across the vehicle's frame from the front passenger reverse power coupler to the front driver wheel, the front passenger reverse power coupler being incorporated into the passenger frame side proximate the front passenger wheel; while the pair of upper and lower trailing links is oriented longitudinally and forwardly from the mid-point of the driver frame side to the front driver wheel. The one end of the upper leading link is affixed to a flexible joint, the flexible joint being pivotally attached to a mounting bracket, the mounting bracket being affixed to the middle of the front passenger reverse power coupler in-between the input and output shafts, and the one end of the lower leading link is affixed to a flexible joint, the flexible joint being pivotally attached to a mounting bracket, the mounting bracket being affixed to the bottom of the front passenger reverse power coupler below the output shaft. Also each shaft and mounting bracket projects inward towards the engine bay. The one ends of the upper and lower trailing links are affixed to flexible joints, the flexible joints being pivotally attached to mounting brackets, the mounting brackets being vertically affixed to the top and bottom of the driver frame side near its mid-point, respectively. Also each mounting bracket projects outward away from the engine bay. The other ends of the upper leading and trailing links are attached to the upper apex bracket while the other ends of the lower leading and trailing links are attached to the lower apex bracket. The upper and lower apex brackets each contain a ball joint, and in turn, the ball joints are pivotally attached to the top and bottom of the driver steering knuckle, respectively, (3) a differential housing assembly as discussed above is affixed to the front end of the vehicle thereby locating the front differential housing in-between the two frame-mounted reverse power couplers, (4) power is transmitted from the front differential housing to the input shaft of the front passenger reverse power coupler with a standard short axle shaft equipped with U or CV-joints; and, then from the output shaft of the front passenger reverse power coupler to the front driver wheel with a similarly equipped standard long axle shaft. The combined effects of the long axle shaft of proper length and vertical orientation of the input and output shafts and upper and lower leading link mounting brackets on the reverse power coupler enable the U or CV-joints on one and the other ends of the long axle shaft to be coincident with the flexible joints on the one ends of the upper and lower leading links and ball joints pivotally attached to the top and bottom of the driver steering knuckle, respectively, throughout the entire range of suspension travel. The coincident joint process allows the U or CV-joints on one and the other ends of the long axle shaft to be attached to the output shaft of the front passenger reverse power coupler and front driver wheel hub, respectively. The front driver wheel hub has one and the other sides such that one side is rotatably attached to the driver steering knuckle and the other side is attached to the front driver wheel; and (5) repeat steps 2-4 beginning with the front passenger wheel. This then represents a powered extreme-travel independent front suspension design concept.

So far, this drivetrain design concept has been discussed within the context of a 4WD independent front suspension system. Given that the drivetrain for the front suspension system is analogous to that for the rear suspension system, then delivering power to the wheels in an independent front suspension system as discussed above can, in principle, be replicated to the wheels in an independent rear suspension system. Therefore, this drivetrain design concept can, in principle, be applied to the independent rear suspension system of a 4WD vehicle.

### Drive Shaft Geometry

The transmission of power among the components of the powertrain and drivetrain in a vehicle is typically accomplished with drive shafts or axle shafts. The connections between these components and drive shafts or axle shafts involve U or CV-joints, whereby the angles adopted by the U or CV-joints are dependent upon the locations of these components within the frame. For purposes of discussion, the locations of these components are described on the basis of a line passing through the longitudinal axis along the center of the vehicle. This line refers to a reference line that is called the longitudinal line. The present invention represents a drivetrain whose components involve the front and rear differential housings, and employs a powertrain whose components include an engine, transmission, and transfer case. The engine, transmission, and input and other output shafts of the transfer case lie on this longitudinal line. Also, both the front and rear differential housings are located on this longitudinal line in order to optimize the operating efficiency of the drivetrain, this optimization being derived from two important factors, these factors being discussed below:

Factor one refers to the properties of the short axle shafts: a differential housing lying on the longitudinal line yields a short axle shaft with the greatest possible length and U or CV-joints with the smallest possible angle. This way, a differential housing lying on the longitudinal line is associated with two short axle shafts, each of which has the same length and U or CV-joints with the same angle. Alternatively, if a differential housing is positioned away from the longitudinal line and closer to one frame side than the other frame side, then the length and U or CV-joint angle associated with one short axle shaft will be different than that associated with the other short axle shaft, thereby imposing more stress on the short axle shaft possessing the smaller length and the U or CV-joint with the greater angle.

Factor two refers to the proximity of the differential housing and both pairs of leading links during suspension compression/bottoming out. This proximity represents how close the other ends of both pairs of leading links approach the differential housing as the other ends of both pairs of leading links arc upwards into their respective frame side apertures and encroach into the space occupied by the differential housing during suspension compression/bottoming out. If the differential housing lies on the longitudinal line, this proximity represents the greatest possible distance between the differential housing and the other ends of both pairs of leading links. Alternatively, if the differential housing is positioned away from the longitudinal line and closer to one frame side than the other frame side, then the differential housing will be closer to the other ends of one pair of leading links than the other ends of the other pair of leading links. This proximity now represents a relatively small distance between the differential housing and other ends of the one pair of leading links, thereby invoking possible contact between the differential housing and other ends of the one pair of leading links during suspension compression/bottoming out.

The drivetrain arrangement in a production-based 4WD vehicle includes the front differential housing being offset from the longitudinal line and located closer to one frame side than the other frame side while the rear differential housing is located on the longitudinal line. This offset is necessary in order to align the front differential housing with the front drive shaft, whereby the front drive shaft is also offset from the longitudinal line in order to avoid interference with the engine and transmission. This interference would otherwise occur due to the front drive shaft being used to transmit power from a location behind the transmission to the front differential housing, this location usually being a transfer case. In contrast, the drivetrain arrangement in a customized, purpose-built, front-engine 4WD vehicle with independent front suspension, includes both front and rear differential housings being located on the longitudinal line. As discussed earlier, the front differential housing is located in the center of the differential housing assembly on the longitudinal line for the purpose of maximizing suspension travel and articulation.

In a 4WD vehicle, the usual method of delivering power to both front and rear wheels involves the use of a transfer case. The transfer case is a type of gearbox whose internal workings include gears, a chain, a shift mechanism and transmission gear-set, and one input shaft and two output shafts, whereby the shafts protrude out of the gearbox. The transfer case is usually connected directly to the back end of the transmission and serves to receive power from the transmission and then distribute it to both the front and rear differential housings. Distribution of power is enabled via the shift mechanism and transmission gear-set, which act to selectively deliver power to the rear or front and rear differential housings, and to select a high or low speed of travel. Transmission of power is governed by the layout of the one input shaft and two output shafts, as follows: the input shaft and other output shaft lie on the longitudinal line while the one output shaft is offset from the longitudinal line, thereby aligning the input shaft with the transmission, the one output shaft with the front differential housing, and the other output shaft with the rear differential housing. This way, the input shaft can be connected directly to the transmission, and one and the other output shafts can be attached to the pinion shafts of the front and rear differential housings with the front and rear drive shafts, respectively. Given that the front drive shaft is offset from the longitudinal line and lies alongside the engine and transmission while the rear drive shaft lies on the longitudinal line, then the front and rear differential housings are usually positioned away from and on the longitudinal line, respectively. This positioning is chosen so that the angles adopted by the U or CV-joints of the front and rear drive shafts can be minimized, thereby ensuring that power is transmitted smoothly, efficiently, and free of vibration from the transfer case to the front and rear differential housings, respectively.

In general, the greater the angulation of the U or CV-joints in a drive shaft, then the greater is the wear and vibration associated with the drive shaft and the loss of efficiency in transmitting power via the drive shaft. The angles adopted by the U or CV-joints of the drive shafts can be minimized with a two-step orientation procedure: first, by positioning one and the other output shafts of the transfer case on the same lines as the pinion shafts of the front and rear differential housings, respectively, the same lines paralleling the longitudinal axis of the vehicle; and second, by aligning one and the other output shafts of the transfer case with the pinion shafts of the front and rear differential housings, respectively. Positioning one and the other output shafts of the transfer case on the same lines as the pinion shafts of the front and rear differential housings is achieved by securing the transfer case and front and rear differential housings to the frame such that one and the other output shafts of the transfer case lie on the same lines as the pinion shafts of the front and rear differential housings, respectively. For a production based 4WD vehicle, the one output shaft of the transfer case and pinion shaft of the front differential housing lie on a line that is offset from the longitudinal axis of the vehicle; whereas, the other output shaft of the transfer case and pinion shaft of the rear differential housing lie on a line passing through the longitudinal axis of the vehicle. Aligning one and the other output shafts of the transfer case with the pinion shafts of the front and rear differential housings is achieved by rotating the front and rear differential housings about their axle tubes such that the pinion shafts adopt a specific alignment relative to one and the other output shafts, respectively. The geometry of the alignment depends of the type of U or CV-joint attached to the ends of the drive shaft.

Given that the front differential housing in a production-based 4WD vehicle is offset from the longitudinal line while the front differential housing in a customized, purpose-built, front-engine 4WD vehicle lies on the longitudinal line, then the angles of the U or CV-joints in the front drive shaft in a production-based 4WD vehicle are able to be minimal while those in a customized, purpose-built, front-engine 4WD vehicle can be significant. Therefore, drive shaft wear and vibration are not issues in a production-based 4WD vehicle, but can be in a customized, purpose-built, front-engine 4WD vehicle. To rectify these unwanted wear and vibration problems, customized, purpose-built, front-engine 4WD vehicles are constructed with specialized drivetrain components. These specialized drivetrain components may involve front drive shafts comprised of multiple CV-joints. However, successful operation of the CV-joints requires a specific alignment between the one output shaft of the transfer case and pinion shaft of the front differential housing. This alignment may be difficult to achieve when the one output shaft of the transfer case is offset from the longitudinal line and pinion shaft of the front differential housing is located on the longitudinal line, therefore resulting in a certain amount of drive shaft vibration. Particularly with alignments that involve the one output shaft of the transfer case being parallel to the pinion shaft of the front differential housing.

As discussed above, in the present invention both front and rear differential housings are located on the longitudinal line as well as the other output shaft of the transfer case. Also, the other output shaft of the transfer case is oriented with the pinion shaft of the rear differential housing by the two-step orientation procedure explained above. This orientation yields minimized angles adopted by the U or CV-joints of the rear drive shaft, which in turn facilitates the smooth, efficient, and vibration-free transmission of power from the transfer case to the rear differential housing. In contrast, the location of the front differential housing on the longitudinal line can lead to wear and vibration problems in the drivetrain. Given the uncertainty surrounding current techniques, the present invention seeks an alternative method of transmitting power to the front differential housing besides a front drive shaft comprised of multiple CV-joints.

### Offset Power Coupler

Consider the following alternative method: Given that a transfer case in an ordinary 4WD vehicle acts to offset the transmission of power from the longitudinal line, then in principle, a gearbox that functions like a transfer case can be used to restore that offset transmission of power back to the longitudinal line. Henceforth, this gearbox is called an offset power coupler and is included in this drivetrain design concept. The offset power coupler functions like a transfer case, but lacks a shifting mechanism and instead consists of internal workings that include gears and a chain, and just one input shaft and one output shaft, whereby the shafts protrude out of and on opposite sides of the gearbox. As mentioned above, the input shaft of the transfer case is attached to the end of the transmission such that the one output shaft is offset from the longitudinal line and directed towards the front of the vehicle while the other output shaft is directed towards the rear differential housing. The offset power coupler is located in-between the engine and front differential housing such that the input shaft is offset from the longitudinal line and directed towards the rear of the vehicle, and the output shaft lies on the longitudinal line and is directed towards the front differential housing. If the position and amount of the offset of the input shaft of the offset power coupler is the same as that of the one output shaft of the transfer case, then the input shaft of the offset power coupler is oriented with the one output shaft of the transfer case thereby indicating that the offset power coupler and transfer case can be connected together with a front drive shaft whose U or CV-joints are associated with minimal angles. In operation, the offset power coupler behaves opposite that of a transfer case and acts to receive power that is offset from the longitudinal line and then restore that power back to the longitudinal line. This way, power can be transmitted smoothly, efficiently, and free of vibration from the transfer case to the offset power coupler. Then the power is further transmitted smoothly, efficiently, and free of vibration from the offset power coupler to the front differential housing even though the front differential housing lies on the longitudinal line.

The offset power coupler is unique and, in principle, represents a successful technique in transmitting power to the front differential housing in the present invention. Endeavoring to reduce the space constraints between the engine and front differential housing, and to eliminate the complexity and cost associated with adding a second front drive shaft between the offset power coupler and front differential housing, then the offset power coupler can be connected directly to the front differential housing in the same manner that the transfer case is connected directly to the back end of the transmission. This direct connection refers to the output shaft of the offset power coupler being adapted to drive the pinion shaft of the front differential housing. Also, the input shaft of the offset power coupler can be oriented with the one output shaft of the transfer case by, one, “clocking” the offset power coupler about the surface of the connection to the front differential housing and, two, rotating the front differential housing about the mounting brackets that secure the front differential housing to the frame. Orientation of the input shaft of the offset power coupler with the one output shaft of the transfer case serves to minimize the angles adopted by the U or CV-joints of the front drive shaft, thereby facilitating the smooth, efficient, and vibration-free transmission of power from the transfer case to the offset power coupler, and therefrom, to the front differential housing.

### BRIEF SUMMARY OF THE INVENTION

The present invention represents a novel drivetrain whose components include differential housing assemblies, reverse power couplers, offset power coupler, and axle shafts. The reverse power coupler comprises two or more gear sprockets, an input shaft, and an output shaft whereby both shafts protrude from the same side of the gearbox, and the offset power coupler comprises a chain and gears, one input shaft, and one output shaft whereby the shafts protrude from opposite sides of the gearbox.

The present invention also represents a drivetrain that:

is specifically designed to operate in conjunction with the suspension design concept disclosed in U.S. application Ser. No. 14/059,062;
is specifically designed for a 4WD vehicle;

employs both a long axle shaft of proper length and a vertical orientation of the input and output shafts and upper and lower leading link mounting brackets on the reverse power coupler that act in cooperation to enable the U or CV-joints on one and the other ends of the long axle shaft to be coincident with the flexible joints on the one ends of the upper and lower leading links and ball joints attached to the top and bottom of the knuckle, respectively, throughout the entire range of suspension travel, the coincident joint process allowing the present invention to be successfully integrated into the aforementioned suspension design concept;

minimizes un-sprung weight by directly or indirectly mounting the drivetrain components to the frame thereby furnishing the aforementioned suspension design concept with the handling quality like an independent suspension system; minimizes angulation of the U or CV-joints of the front drive shaft thereby facilitating the smooth, efficient, and vibration-free transmission of power from the transfer case to the offset power coupler and therefrom the front differential housing;

possesses differential housing assemblies, each assembly consisting of a differential housing, mounting brackets, and U or CV-joint flanges. The U or CV-joint flanges serve as the connection locations between the differential housing and short axle shafts. The mounting brackets are oriented so as to facilitate suspension travel during compression, and serve to mount the differential housing to the frame in-between the respective reverse power couplers, the combination of differential housing and mounting brackets adding strength and rigidity to the frame;

possesses unique frame-mounted reverse power couplers, whereby power is transmitted from the differential housing to each reverse power coupler with a short axle shaft then from each reverse power coupler to the other front or rear wheel with a long axle shaft, each reverse power coupler being incorporated into the one frame side proximate the one front or rear wheel, respectively;

possesses an offset power coupler whose input shaft is oriented with the one output shaft of the transfer case so as to minimize the angulation of the U or CV-joints of the front drive shaft, and whose output shaft is adapted to the pinion shaft of the front differential housing.

### BRIEF DESCRIPTION OF THE SEVERAL VIEWS OF THE DRAWING

### List of Reference Numerals Utilized in the Drawings

10—frame
11—engine
12—transmission
13—transfer case
14—front differential housing
15—rear differential housing
16—offset power coupler
17—front driver reverse power coupler
18—front passenger reverse power coupler
19—rear driver reverse power coupler
20—rear passenger reverse power coupler
21—front drive shaft
22—rear drive shaft
23—front driver short axle shaft
24—front passenger short axle shaft
25—front driver long axle shaft
26—front passenger long axle shaft
27—rear driver short axle shaft
28—rear passenger short axle shaft
29—rear driver long axle shaft
30—rear passenger long axle shaft
31—driver upper leading link
32—driver lower leading link
33—passenger upper leading link
34—passenger lower leading link
35—driver upper trailing link
36—driver lower trailing link
37—passenger upper trailing link
38—passenger lower trailing link
39—driver upper apex bracket
40—driver lower apex bracket
41—passenger upper apex bracket
42—passenger lower apex bracket
43—driver steering knuckle
44—passenger steering knuckle
45—driver non-steering knuckle
46—passenger non-steering knuckle
47—engine mounting bracket
48—engine cross-member
49—transmission mounting bracket
50—transmission cross-member
51—driver differential housing mounting bracket
52—passenger differential housing mounting bracket
53—upper leading link mounting bracket
54—lower leading link mounting bracket
55—trailing link mounting bracket

### BRIEF DESCRIPTION OF THE DRAWINGS

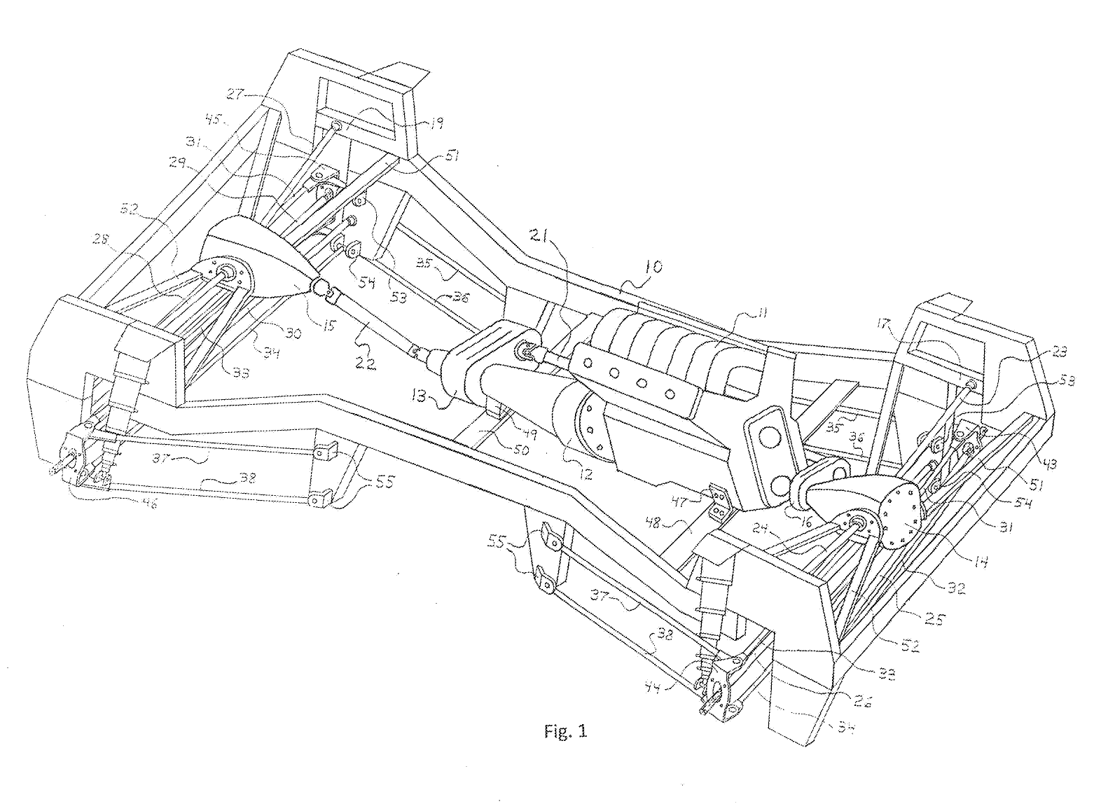

FIG. 1 is a front side perspective view of the drivetrain and suspension system for a 4WD vehicle;

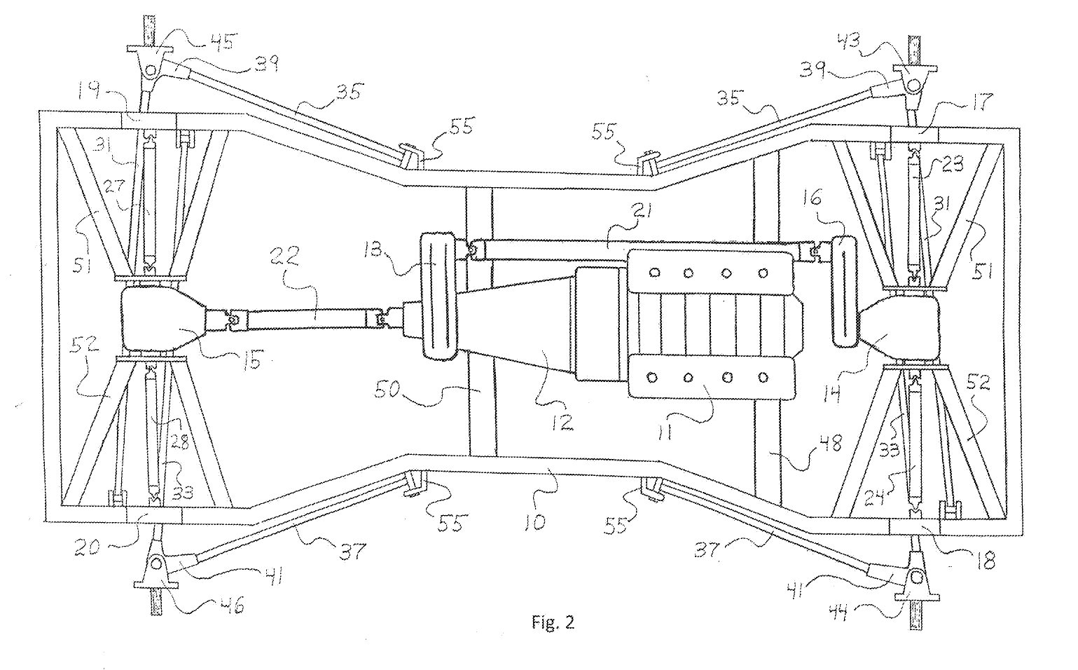

FIG. 2 is a top plan view thereof;

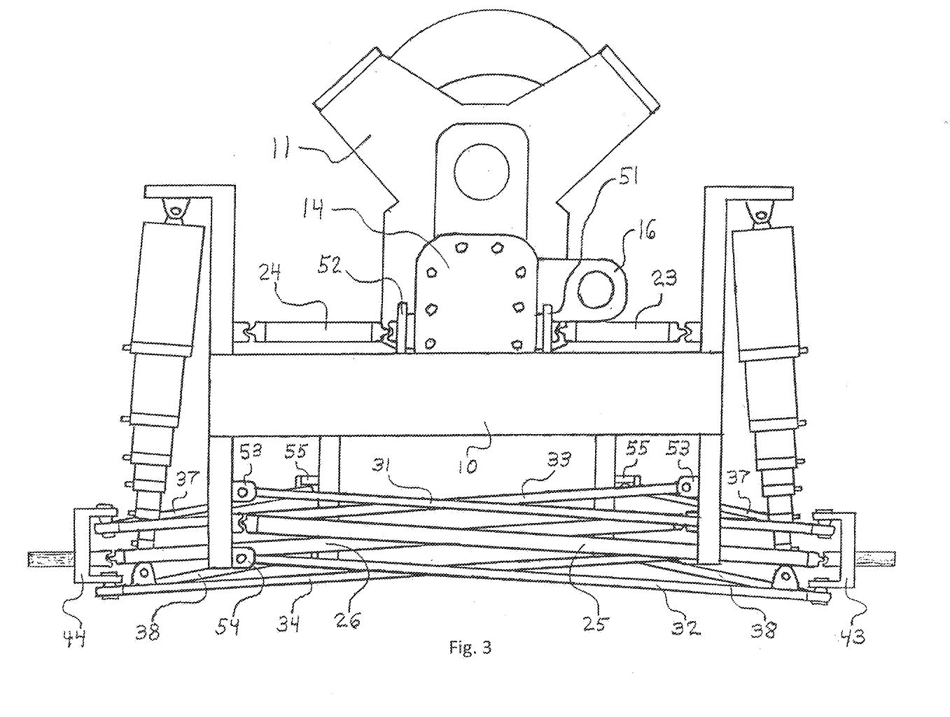

FIG. 3 is a front view of the front drivetrain and suspension system at ride height thereof;

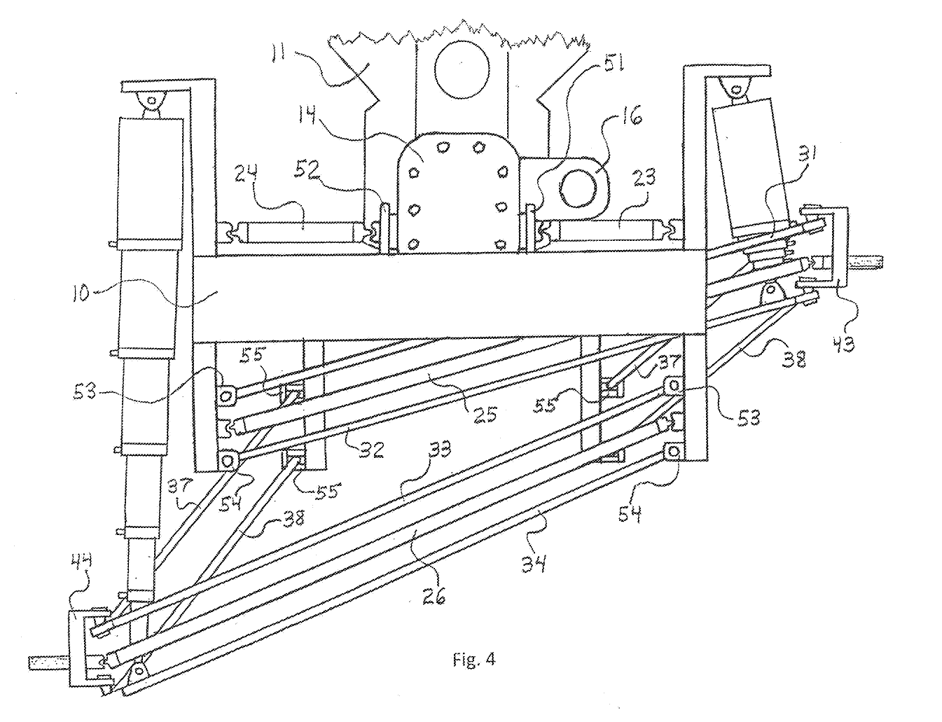

FIG. 4 is a front view of the front drivetrain and suspension system articulated thereof.

### DETAILED DESCRIPTION OF THE INVENTION

The present invention is directed to a drivetrain which is operably installed with the front and rear independent suspension systems disclosed in U.S. patent application Ser. No. 14/059,062, each suspension system based on a type of double wishbone configuration per wheel. The drivetrain includes means for receiving power at one frame side and then delivering that power to the wheel opposite the one frame side, this means accomplished via a unique gearbox known as a reverse power coupler.

Referring now to the drawings, a drivetrain for a four-wheel drive vehicle is schematically shown installed within a frame 10 and interactively associated with a powertrain. The drivetrain includes the front and rear differential housings 14 and 15, offset power coupler 16, and front and rear driver and passenger reverse power couplers 17 and 18, and 19 and 20, respectively; and the powertrain includes an engine 11, transmission 12, and transfer case 13. The means for transmitting power from one drivetrain or powertrain component to another include the front and rear drive shafts 21 and 22, front and rear driver and passenger short axle shafts 23 and 24, and 27 and 28, and front and rear driver and passenger long axle shafts 25 and 26, and 29 and 30, respectively. In particular, the layout of the front and rear driver and passenger short axle shafts 23 and 24, and 27 and 28, and front and rear driver and passenger long axle shafts 25 and 26, and 29 and 30, respectively, within the drivetrain is governed by the configuration of the double wishbone suspension system. This configuration includes pairs of driver and passenger upper and lower leading links 31 and 32, and 33 and 34 and pairs of driver and passenger upper and lower trailing links 35 and 36, and 37 and 38, respectively.

The key component of the drivetrain is the front or rear driver or passenger reverse power coupler 17 or 18, or 19 or 20, respectively. The front or rear driver or passenger reverse power coupler 17 or 18, or 19 or 20 is a gearbox whose internal components include two or more gear sprockets, an input shaft, and an output shaft, and whose external components include the input and output shafts and upper and lower leading link mounting brackets 53 and 54 for a pair of passenger or driver upper and lower leading links 33 and 34, or 31 and 32, respectively. The input and output shafts protrude out of the gearbox and the upper and lower leading link mounting brackets 53 and 54, respectively, are affixed to the outer surface of the gearbox. The gear sprockets are adapted to the input and output shafts, whereby the combination of each gear sprocket and shaft acts as a single unit such that each unit as well as the other gear sprockets are rotationally affixed to the inside of the gearbox. Also the teeth on the gear sprockets in the units intermesh with those on the other gear sprockets such that power is transmitted internally from the input shaft to the output shaft via the rotational interaction among the gear sprockets in the units and other gear sprockets. This way, the front or rear driver or passenger reverse power coupler 17 or 18, or 19 or 20 behaves like a hub reduction gearbox, thereby acting to transmit power from the front or rear differential housing 14 or 15 to the driver or passenger wheel (not shown), respectively, as follows: Each input or output shaft is attached to the front or rear driver or passenger short axle shaft 23 or 24, or 27 or 28, or long axle shaft 25 or 29, or 26 or 30 such that each front or rear driver or passenger short axle shaft 23 or 24, or 27 or 28 serves to transmit power from the front or rear differential housing 14 or 15 to the front or rear driver or passenger reverse power coupler 17 or 18, or 19 or 20, while each front or rear driver or passenger long axle shaft 25 or 29, or 26 or 30 serves to transmit power from the front or rear passenger or driver reverse power coupler 18 or 17, or 20 or 19 to the front or rear driver or passenger wheel hub, respectively. The front or rear driver or passenger reverse power coupler 17 or 18, or 19 or 20 is incorporated into a driver or passenger frame side proximate the driver or passenger wheel, respectively. This incorporation refers to a process in which the driver or passenger frame side is fabricated in such a manner that the front or rear driver or passenger reverse power coupler 17 or 18, or 19 or 20 is an integral part of the driver or passenger frame side, respectively. The process of incorporation is implemented in such a manner that the external components are positioned on the same side of the front or rear driver or passenger reverse power coupler 17 or 18, or 19 or 20 in a vertical orientation such that in descending order the input shaft is the top component, followed by the upper leading link mounting bracket 53, then the output shaft, and then the lower leading link mounting bracket 54 is the bottom component, whereby each shaft and mounting bracket projects inward towards the engine bay. This vertical orientation: one, replicates the manner in which the upper and lower leading link mounting brackets 53 and 54 are affixed to the frame sides in the suspension system disclosed in the aforementioned patent application, whereby that manner is a top and bottom orientation of the upper and lower leading link mounting brackets 53 and 54, respectively; and two, refers to the front or rear driver and passenger reverse power couplers 17 and 18, or 19 and 20 being incorporated into the driver and passenger frame sides next to and on opposite sides of the vertical edges bordering the apertures, respectively. An aperture refers to an open space being fabricated into a driver or passenger frame side in such a manner that the other ends of a pair of driver or passenger upper and lower leading links 31 and 32, or 33 and 34 and driver or passenger long axle shaft 25 or 29, or 26 or 30, respectively, can travel upward into the aperture during suspension compression thereby enhancing the travel capability of the suspension system disclosed in the aforementioned patent application.

The offset power coupler 16 is a gearbox whose internal components include a chain and gears, one input shaft, and one output shaft. The input and output shafts protrude out of and on opposite sides of the gearbox, whereby they are offset from and lie on the longitudinal line, respectively. The gears are adapted to the input and output shafts, whereby the combination of each gear and shaft acts as a single unit, and that is rotationally affixed to the inside of the gearbox. Also, the gear and input shaft unit is spatially separated from the gear and output shaft unit, but the gear and input shaft unit is indirectly connected to the gear and output shaft unit via a common association with the chain. This common association refers to the teeth on each gear intermeshing with the links on the chain such that power is transmitted internally from the input shaft to the output shaft via the rotational interaction among the gears and chain. The input shaft is attached to the front drive shaft 21 and the output shaft is attached to the pinion shaft of the front differential housing 14, whereby the front drive shaft 21 serves to transmit power from the transfer case 13 to the offset power coupler 16. The offset power coupler 16 functions like, but behaves opposite that of the transfer case 13, thereby acting to restore the offset transmission of power back to the longitudinal line. Given that the transmission of power is offset from the longitudinal line by the operation of the one output shaft of the transfer case 13, then the offset power coupler 16 acts to restore the transmission of power back to the longitudinal line by making a connection, initially, to the one output shaft of the transfer case 13 with an input shaft that is offset from the longitudinal line, and finally, to the pinion shaft of the front differential housing 14 with an output shaft that lies on the longitudinal line. The connection to the transfer case 13 is made with the front drive shaft 21 whose U or CV-joints are associated with minimal angles, whereby the angles adopted by the U or CV-joints are minimized via an orientation process between the one output shaft of the transfer case 13 and the input shaft of the offset power coupler 16. This orientation is the result of, one, “clocking” the offset power coupler 16 about the connection to the front differential housing 14, and two, rotating the front differential housing 14 about its pair of driver and passenger differential housing mounting brackets 51 and 52 such that the position and amount of the offset of the input shaft of the offset power coupler 16 is the same as that of the one output shaft of the transfer case 13. The offset refers to a line that is parallel to and offset from the longitudinal line. The angles of the U or CV-joints are minimized in order to facilitate a smooth, efficient, and vibration-free transmission of power from the transfer case 13 to the offset power coupler 16, thereby minimizing the wear and vibration effects on the drivetrain. The offset power coupler 16 is secured to the frame 10 via a direct connection to the front differential housing 14, the direct connection referring to the output shaft of the offset power coupler 16 being adapted to the pinion shaft of the front differential housing 14.

The front or rear differential housing 14 or 15 is a component of the front or rear differential housing assembly. Each differential housing assembly also includes driver and passenger differential housing mounting brackets 51 and 52 and U or CV-joint flanges, and is located at the front or rear end of the frame 10, respectively. The front or rear differential housing 14 or 15 has driver and passenger sides, and each side is machined and then attached to a U or CV-joint flange. Each U or CV-joint flange serves as a connection location for the front or rear driver or passenger short axle shaft 23 or 24, or 27 or 28, respectively. Each front or rear driver or passenger short axle shaft 23 or 24, or 27 or 28 serves to transmit power from the front or rear differential housing 14 or 15 to the front or rear driver or passenger reverse power coupler 17 or 18, or 19 or 20, respectively. Each driver or passenger differential housing mounting bracket 51 or 52 consists of a semi-circular steel plate and a pair of steel strips. The plate is machined at a center-point to yield a hole whereby the hole is shaped in such a manner that the plate can be passed over the U or CV-joint flange and attached directly to the side of the front or rear differential housing 14 or 15, respectively. Each strip in a pair of strips has one and the other ends, whereby the one ends are attached perpendicularly to their respective outer edges of the flat section of the plate and the other ends are attached to their respective sides of a frame side aperture. Each pair of strips is oriented in such a manner that, one, the front or rear differential housing 14 or 15 is positioned in-between the front or rear driver and passenger reverse power couplers 17 and 18, or 19 and 20 on a longitudinal line passing along the vehicle's central axis, with the U or CV-joint flanges being positioned on a line passing through the front or rear wheels (not shown), respectively, and two, an open space is created in-between the strips such that the underlying driver or passenger upper and lower leading links 31 and 32, or 33 and 34 and front or rear driver or passenger long axle shaft 25 or 26, or 29 or 30 can travel upward in-between the strips and into the driver or passenger frame side aperture when the suspension compresses, respectively. A pair of driver and passenger differential housing mounting brackets 51 and 52 is attached to the driver and passenger sides of the front or rear differential housing 14 or 15 on the plate end and to the front or rear driver and passenger frame sides on the strip ends, respectively. In this way, the front or rear differential housing 14 or 15 is secured to the frame 10 with the pair of driver and passenger mounting brackets 51 and 52, respectively. The combination of the front or rear differential housing 14 or 15 and attached pair of driver and passenger differential housing mounting brackets 51 and 52 refers to the front or rear differential housing assembly. The front or rear differential housing assembly serves as a single structural unit that acts to strengthen and solidify the front or rear framework thereby providing additional structure to the frame 10, respectively. The front or rear framework contains the front or rear driver and passenger reverse power couplers 17 and 18, or 19 and 20; and the front or rear driver and passenger reverse power couplers 17 and 18, or 19 and 20 represent the surfaces to which are affixed the upper and lower leading link mounting brackets 53 and 54 that attach the passenger and driver upper and lower leading links 33 and 34, and 31 and 32 to the front or rear end of the frame 10, respectively.

Principal to the objective of the present invention is the integration of the front or rear driver and passenger reverse power couplers 17 and 18, or 19 and 20 into the suspension system as noted above. In particular, the incorporation of the front or rear driver and passenger reverse power couplers 17 and 18, or 19 and 20 into the driver and passenger frame sides enables power to be transmitted from the front or rear differential housing 14 or 15 to the front or rear wheels in a vehicle equipped with the front or rear independent suspension system whose configuration includes driver and passenger pairs of upper and lower leading links 31 and 32, and 33 and 34 and driver and passenger pairs of upper and lower trailing links 35 and 36, and 37 and 38, respectively. Each pair of driver or passenger upper and lower leading links 31 and 32, or 33 and 34 extends laterally from the front or rear passenger or driver reverse power coupler 18 or 17, or 20 or 19 to the driver or passenger wheel, the front or rear passenger or driver reverse power coupler 18 or 17, or 20 or 19 being proximate the passenger or driver wheel, respectively; whereas each driver or passenger pair of upper and lower trailing links 35 and 36, or 37 and 38 extends longitudinally from the mid-point of the driver or passenger frame side to the driver or passenger wheel, respectively. The one end of the driver or passenger upper leading link 31 or 33 is affixed to a flexible joint, the flexible joint being pivotally attached to mounting bracket 53, mounting bracket 53 being affixed to the middle of the front or rear passenger or driver reverse power coupler 18 or 17, or 20 or 19 in-between the input and output shafts, and the one end of the driver or passenger lower leading link 32 or 34 is affixed to a flexible joint, the flexible joint being pivotally attached to mounting bracket 54, mounting bracket 54 being affixed to the bottom of the front or rear passenger or driver reverse power coupler 18 or 17, or 20 or 19 below the output shaft, respectively. Also each shaft and mounting bracket 53 or 54 projects inward towards the engine bay. The one ends of the driver or passenger upper and lower trailing links 35 and 36, or 37 and 38 are affixed to flexible joints, the flexible joints being pivotally attached to mounting brackets 55, mounting brackets 55 being vertically affixed to the top and bottom of the driver or passenger frame side near its mid-point, respectively. Also each mounting bracket 55 projects outward away from the engine bay. The other ends of the driver or passenger upper leading and trailing links 31 and 35, and 33 and 37 are attached to a driver or passenger upper apex bracket 39 or 41 while the other ends of the driver or passenger lower leading and trailing links 32 and 36, and 34 and 38 are attached to a driver or passenger lower apex bracket 40 or 42, respectively. The driver or passenger upper and lower apex brackets 39 and 40, or 41 and 42 each contain a ball joint, and in turn, the ball joints are pivotally attached to the top and bottom of a driver or passenger steering knuckle 43 or 44 or driver or passenger non-steering knuckle 45 or 46, respectively. The combined effects of the front or rear driver or passenger long axle shaft 25 or 26, or 29 or 30 of proper length and vertical orientation of the input and output shafts and upper and lower leading link mounting brackets 53 and 54 on the front or rear passenger or driver reverse power coupler 18 or 17, or 20 or 19 enable the U or CV-joints on one and the other ends of the front or rear driver or passenger long axle shaft 25 or 26, or 29 or 30 to be coincident with the flexible joints on the one ends of the pair of driver or passenger upper and lower leading links 31 and 32, or 33 and 34 and ball joints pivotally attached to the top and bottom of the driver or passenger steering or non-steering knuckle 43 or 44, or 45 or 46, respectively, throughout the entire range of suspension travel. The coincident joint process allows the U or CV-joints on one and the other ends of the front or rear driver or passenger long axle shaft 25 or 26, or 29 or 30 to be attached to the output shaft of the front or rear passenger or driver reverse power coupler 18 or 17, or 20 or 19 and front or rear driver or passenger wheel hub (not shown), respectively. The front or rear driver or passenger wheel hub has one and the other sides such that one side is rotatably attached to the driver or passenger steering or non-steering knuckle 43 or 44, or 45 or 46 and the other side is attached to the front or rear driver or passenger wheel, respectively.

Referring particularly to FIG. 2, the powertrain components including the engine 11, transmission 12, and part of the transfer case 13, and drivetrain components including the front and rear differential housings 14 and 15, respectively, and part of the offset power coupler 16 are located in the frame 10 on a line that passes through the longitudinal axis along the center of the vehicle. Specifically, these locations are an artifact of the manner in which the components are secured to the frame 10. The objective of the locations is to facilitate inter-connections among the components. Viewing from the front to the back of the vehicle, select components occupy the longitudinal line in the following order: the front differential housing 14, engine 11, transmission 12, and rear differential housing 15, respectively. In particular, the engine 11 and transmission 12 lie next to each other, both powertrain components being secured to the frame 10 with engine and transmission mounting brackets 47 and 49 and cross-members 48 and 50, respectively, collectively serving as a single, structural sub-frame unit. As described above, the front or rear differential housing 14 or 15 is secured to the frame 10 with a pair of driver and passenger differential housing mounting brackets 51 and 52, the combination of which refers to the front or rear differential housing assembly. The front or rear differential housing assembly serves as a single structural unit that acts to strengthen and solidify the front or rear framework of the vehicle, respectively. The transfer case 13, whose components include an input shaft, and one and the other output shafts, is located in-between the transmission 12 and rear differential housing 15 in such a manner that the input shaft and other output shaft lie on the longitudinal line while the one output shaft is offset from the longitudinal line. This way, the input shaft is directed towards the transmission 12, the one output shaft is directed towards the front of the vehicle, and the other output shaft is directed towards the rear differential housing 15. The offset power coupler 16 is located in-between the engine 11 and front differential housing 14 in such a manner that the input shaft is offset from the longitudinal line while the output shaft lies on the longitudinal line. This way, the input shaft is directed towards the rear of the vehicle and the output shaft is directed towards the front differential housing 14. Lacking their own dedicated mounting brackets, both the transfer case 13 and offset power coupler 16 are indirectly secured to the frame 10 via their connection to other components that do have dedicated mounting brackets, that being the transmission 12 and front differential housing 14, respectively. These component connections are described below.

Referring particularly to FIG. 1, the drivetrain that accompanies the front suspension system includes a front differential housing 14, front driver and passenger reverse power couplers 17 and 18, front driver and passenger short axle shafts 23 and 24, and front driver and passenger long axle shafts, 25 and 26, respectively. As described above: one, the front differential housing 14 is located in-between the front driver and passenger reverse power couplers 17 and 18, respectively; and two, the front driver reverse power coupler 17 is incorporated into the driver frame side proximate the front driver wheel while the front passenger reverse power coupler 18 is incorporated into the passenger frame side proximate the front passenger wheel. The front driver short axle shaft 23 has one and the other ends; as such each end is affixed to a U or CV-joint, whereby the U or CV-joint on the one end is attached to the U or CV-joint flange on the driver side of the front differential housing 14 and that on the other end is attached to the input shaft of the front driver reverse power coupler 17. Likewise, the front driver long axle shaft 25 has one and the other ends; as such each end is affixed to a U or CV-joint, whereby the U or CV-joint on one end is attached to the output shaft of the front passenger reverse power coupler 18 and that on the other end is attached to the front driver wheel hub. The front driver wheel hub has one and the other sides such that one side is rotatably attached to the driver steering knuckle 43 and the other side is attached to the front driver wheel. The front passenger short axle shaft 24 has one and the other ends; as such each end is affixed to a U or CV-joint, whereby the U or CV-joint on one end is attached to the U or CV-joint flange on the passenger side of the front differential housing 14 and that on the other end is attached to the input shaft of the front passenger reverse power coupler 18. Likewise the front passenger long axle shaft 26 has one and the other ends; as such each end is affixed to a U or CV-joint, whereby the U or CV-joint on one end is attached to the output shaft of the front driver reverse power coupler 17 and that on the other end is attached to the front passenger wheel hub. The front passenger wheel hub has one and the other sides such that one side is rotatably attached to the passenger steering knuckle 44 and the other side is attached to the front passenger wheel.

Referring particularly to FIG. 1, the drivetrain that accompanies the rear suspension system includes a rear differential housing 15, rear driver and passenger reverse power couplers 19 and 20, rear driver and passenger short axle shafts 27 and 28, and rear driver and passenger long axle shafts 29 and 30, respectively. As described above: one, the rear differential housing 15 is located in-between the rear driver and passenger reverse power couplers 19 and 20, respectively; and two, the rear driver reverse power coupler 19 is incorporated into the driver frame side proximate the rear driver wheel while the rear passenger reverse power coupler 20 is incorporated into the passenger frame side proximate the rear passenger wheel. The rear driver short axle shaft 27 has one and the other ends; as such each end is affixed to a U or CV-joint, whereby the U or CV-joint on the one end is attached to the U or CV-joint flange on the driver side of the rear differential housing 15 and that on the other end is attached to the input shaft of the rear driver reverse power coupler 19. Likewise the rear driver long axle shaft 29 has one and the other ends; as such each end is affixed to a U or CV-joint, whereby the U or CV-joint on the one end is attached to the output shaft of the rear passenger reverse power coupler 20 and that on the other end is attached to the rear driver wheel hub. The rear driver wheel hub has one and the other sides such that one side is rotatably attached to the driver non-steering knuckle 45 and the other side is attached to the rear driver wheel. The rear passenger short axle shaft 28 has one and the other ends; as such each end is affixed to a U or CV-joint, whereby the U or CV-joint on the one end is attached to the U or CV-joint flange on the passenger side of the rear differential housing 15 and that on the other end is attached to the input shaft of the rear passenger reverse power coupler 20. Likewise the rear passenger long axle shaft 30 has one and the other ends; as such each end is affixed to a U or CV-joint, whereby the U or CV-joint on the one end is attached to the output shaft of the rear driver reverse power coupler 19 and that on the other end is attached to the rear passenger wheel hub. The rear passenger wheel hub has one and the other sides such that one side is rotatably attached to the passenger non-steering knuckle 46 and the other side is attached to the rear passenger wheel.

Referring particularly to FIG. 2, power is transmitted from the engine 11 to the transmission 12 then from the transmission 12 to the transfer case 13 via a direct connection between the engine 11 and transmission 12 and between the transmission 12 and transfer case 13. The direct connection refers to: one, the back of the engine 11 being connected directly to the front of the transmission 12 such that the crankshaft of the engine 11 is adapted to the input shaft of the transmission 12; and two, the back of the transmission 12 being connected directly to the transfer case 13 such that the output shaft of the transmission 12 is adapted to the input shaft of the transfer case 13. The transfer case 13 transmits power to the offset power coupler 16 and rear differential housing 15 via the front and rear drive shafts 21 and 22, respectively. The front drive shaft 21 has a front and rear ends; as such each end is affixed to a U or CV-joint, whereby the U or CV-joint on the front end is attached to the input shaft of the offset power coupler 16 and that on the rear end is attached to the one output shaft of the transfer case 13. Likewise, the rear drive shaft 22 has a front and rear ends; as such each end is affixed to a U or CV-joint, whereby the U or CV-joint on the front end is attached to the other output shaft of the transfer case 13 and that on the rear end is attached to the pinion shaft of the rear differential housing 15. The one and the other output shafts of the transfer case 13 are oriented with the input shaft of the offset power coupler 16 and pinion shaft of the rear differential housing 15 in order to minimize the angles adopted by the U or CV-joints on the front and rear drive shafts 21 and 22, respectively; whereby, the angles of the U or CV-joints are minimized in order to facilitate the smooth, efficient, and vibration-free transmission of power from the transfer case 13 to the offset power coupler 16 and rear differential housing 15. This orientation between the one output shaft of the transfer case 13 and input shaft of the offset power coupler 16 is the result of: one, “clocking” the offset power coupler 16 about its connection to the front differential housing 14; and two, rotating the front differential housing 14 about its pair of driver and passenger differential housing mounting brackets 51 and 52, respectively, such that the position and amount of the offset of input shaft of the offset power coupler 16 is the same as that of the one output shaft of the transfer case 13. The offset refers to a line that is parallel to and offset from the longitudinal line, This orientation between the other output shaft of the transfer case 13 and the pinion shaft of the rear differential housing 15 is the result of, one, locating the other output shaft of the transfer case 13 on the same line as the pinion shaft of the rear differential housing 15, and two, rotating the rear differential housing 15 about its pair of driver and passenger differential housing mounting brackets 51 and 52, respectively. The same line refers to the longitudinal line.

Referring particularly to FIG. 1, power is transmitted from the offset power coupler 16 to the front differential housing 14 via a direct connection between the offset power coupler 16 and front differential housing 14. The direct connection: one, refers to the offset power coupler 16 being connected directly to the front differential housing 14 such that the output shaft of the offset power coupler 16 is adapted to the pinion shaft of the front differential housing 14; and two, ensures that power is further transmitted smoothly, efficiently, and free of vibration. Power is transmitted from the front differential housing 14 to the front driver and passenger reverse power couplers 17 and 18 via the front driver and passenger short axle shafts 23 and 24, then from the front driver and passenger reverse power couplers 17 and 18 to the front passenger and driver wheel hubs via the front passenger and driver long axle shafts 26 and 25, respectively. Whereas, power is transmitted from the rear differential housing 15 to the rear driver and passenger reverse power couplers 19 and 20 via the rear driver and passenger short axle shafts 27 and 28, then from the rear driver and passenger reverse power couplers 19 and 20 to the rear passenger and driver wheel hubs via the rear passenger and driver long axle shafts 30 and 29, respectively. The front or rear driver or passenger wheel hub has one and the other sides such that one side is rotatably attached to the front or rear driver or passenger steering or non-steering knuckle 43 or 44, or 45 or 46 and the other side is attached to the front or rear driver or passenger wheel, respectively.

While the invention has been illustrated and described as embodied in a vehicle drivetrain, it is not intended to be limited to the details shown, since it will be understood that various omissions, modifications, substitutions and changes in the forms and details of the device illustrated and in its operation can be made by those skilled on the art without departing in any way from the scope and spirit of the present invention.

What is claimed is:

1. A drivetrain for use with a vehicle having a frame a powertrain, and front and rear independent suspension systems, the drivetrain comprising:
wherein the frame comprises a driver frame side and a passenger frame side, the frame and each frame side having a front end, rear end, and middle;
front and rear driver and passenger reverse power couplers, each reverse power coupler being a gearbox whose external components include an input shaft and an output shaft;
an offset power coupler; the offset power coupler being a gearbox whose external components include an input shaft and an output shaft;
front and rear differential housing assemblies; the front or rear differential housing assembly includes a front or rear differential housing, respectively; wherein each differential housing has a pinion shaft and driver and passenger sides each side is attached to a differential housing mounting bracket and flexible joint flange;
front and rear driver and passenger short and long axle shafts;
wherein the powertrain includes an engine, transmission, transfer case and front and rear drive shafts; wherein the transfer case comprises an input shaft and first and second output shafts;
wherein each driver or passenger frame side has a pair of apertures, the pair of apertures referring to an aperture being located at the front and rear ends of each frame side; wherein an aperture refers to an open space that is fabricated into a frame side wherein each aperture has a rectangular shape comprised of three straight edges, a horizontal edge and one and the other vertical edges whereby the horizontal edge is positioned at a top of the aperture between one and the other vertical edges, the one vertical edge being closer to the front or rear end of each frame side than is the other vertical edge.

2. The drivetrain of claim 1 wherein the reverse power coupler is a gearbox each gearbox is comprised of both internal and external components;
wherein the internal components include one and the other gearsets, an input shaft, an output shaft, and a connector shaft, each gearset is comprised of one chain and two gears, each chain has links while each gear has teeth; wherein the two gears and chain in one gearset are the first and second gears and one chain while the two gears and chain in the other gearset are the top and bottom gears and other chain, respectively; wherein the two gears in each gearset are spatially separated from each other, yet indirectly connected to each other via a common association with the chain, the common association refers to the teeth on the first and second gears being able to intermesh with the links on the one chain and the teeth on the top and bottom gears being able to intermesh with the links on the other chain; wherein the one gearset is oriented horizontally while the other is oriented vertically, the one gearset is positioned above the other gearset such that the second gear in the one gearset is next to the top gear in the other gearset; wherein the first gear in the one gearset is adapted to the input shaft, the bottom gear in the other gearset is adapted to the output shaft, and the second gear in the one gearset is adapted to the top gear in the other gearset with the connector shaft; wherein each gear/shaft adaptation acts as a single unit, each unit is rotationally affixed to the inside of the gearbox and is able to rotationally interact; wherein the rotational interaction refers to the intermeshing among the gears and chains such that power is transmitted internally from the first gear/input shaft unit to the second gear/top gear/connector shaft unit, then from the second gear/top gear/connector shaft unit to the bottom gear/output shaft unit;
wherein the external components include the input and output shafts and an upper and lower leading link mounting brackets; wherein the input and output shafts protrude out of the gearbox while the upper and lower leading link mounting brackets are affixed to an outer surface of the gearbox, all external components are positioned on a same side of the gearbox;
wherein the front driver or passenger reverse power coupler is incorporated into the front end of the driver or passenger frame side proximate a front driver or passenger wheel, the incorporation refers to a process in which the driver or passenger frame side is fabricated in a manner such that the front driver or passenger reverse power coupler is an integral part of the driver or passenger frame side, the horizontal and vertical gearsets being located inside the frame side, respectively; wherein the process of incorporation is implemented in a manner such that the second gear/top Rear/connector shaft unit is located at an upper corner of the aperture either next to the horizontal and other vertical edges of the aperture on the driver frame side or next to the horizontal and one vertical edges of the aperture on the passenger frame side; wherein the horizontal gearset is positioned above the aperture in a manner that enables the flexible joint flange on the driver or passenger side of the front differential housing to be aligned with the input shaft while the vertical gearset and other external components are positioned either next to the other vertical edge of the aperture on the driver frame side or next to the one vertical edge of the aperture on the passenger frame side; wherein the other external components are oriented vertically in the descending order the upper leading link mounting bracket is a top component, followed by the output shaft, and then the lower leading link mounting bracket is a bottom component; wherein each shaft and mounting bracket projects inward towards an engine bay;
wherein the rear driver or passenger reverse power coupler is incorporated into the rear end of the driver or passenger frame side proximate a rear driver or passenger wheel, the incorporation refers to a process in which the driver or passenger frame side is fabricated in a manner such that the rear driver or passenger reverse power coupler is an integral part of the driver or passenger frame side, the horizontal and vertical gearsets being located inside the frame side, respectively; wherein the process of incorporation is implemented in a manner such that the second gear/top gear/connector shaft unit is located at the upper corner of the aperture either next to the horizontal and other vertical edges of the aperture on the driver frame side or next to the horizontal and one vertical edges of the aperture on the passenger frame side; wherein the horizontal gearset is positioned above the aperture in a manner that enables the flexible joint flange on the driver or passenger side of the rear differential housing to be aligned with the input shaft while the vertical gear set and other external components are positioned either next to the other vertical edge of the aperture on the driver frame side or next to the one vertical edge of the aperture on the passenger frame side; wherein the other external components are oriented vertically in the descending order the upper leading link mounting bracket is the top component, followed by the output shaft, and then the lower leading link mounting bracket is the bottom component; wherein each shaft and mounting bracket projects inward towards the engine bay.

3. The drivetrain of claim 1 wherein the offset power coupler is a gearbox comprised of both internal and external components wherein the internal components include a chain first and second gears, an input shaft, and an output shaft whereby the chain has links and each gear has teeth; whereto the external components refer to the input and output shafts protruding out of and occupying opposite sides of the gearbox;
wherein the first and second gears are spatially separated from each other, yet indirectly connected to each other via a common association with the chain, the common association refers to the teeth on each gear being able to intermesh with the links on the chain; wherein the first and second gears are adapted to the input and output shafts, respectively, such that each gear/shaft adaptation acts as a single unit, each unit is rotationally affixed to the inside of the gearbox and is able to rotationally interact; wherein this rotational interaction refers to the intermeshing among the gears and chain such that power is transmitted internally from the first gear/input shaft unit to the second gear/output shaft unit;
wherein the offset power coupler is directly connected to the front differential housing such that the output shaft of the offset power coupler is adapted to the pinion shaft of the front differential housing; wherein the offset power coupler is indirectly secured to the frame due to the offset power coupler being directly connected to the front differential housing while the front differential housing is secured to the frame.

4. The drivetrain of claim 1 wherein the front or rear differential housing assembly comprises the front or rear differential housing, respectively, driver and passenger differential housing mounting brackets, and flexible joint flanges; wherein each side of the front or rear differential housing is machined and then attached to the flexible joint flange;
wherein the driver or passenger differential housing mounting bracket consists of a semi-circular flat steel plate and one and the other steel strips, the semi-circle refers to a shape comprised of a curved edge with first and second end-points, the first and second end-points being joined together with a straight edge; wherein the plate is machined at a center-point to yield a hole the hole is shaped in a manner such that the plate can be passed over the flexible joint flange and attached directly to the side of the differential housing; wherein the first end-point is located between the driver or passenger flexible joint flange and either the front end of the driver or passenger frame side or the rear end of the driver or passenger frame side while the second end-point is located between the driver or passenger flexible joint flange and middle of the driver or passenger frame side; wherein the plate occupies a vertical plane parallel to the longitudinal line while each strip occupies a horizontal plane perpendicular to the vertical plane occupied by the plate;
wherein each strip has a first and second ends and is positioned at the front or rear end of the frame; wherein the first end of one strip is attached to the first end-point of the plate while the first end of the other strip is attached to the second end-point of the plate; whereas, the second end of one strip is attached to the driver or passenger frame side next to the one vertical edge of the aperture while the second end of the other strip is attached to the driver or passenger frame side next to the other vertical edge of the aperture, respectively;
wherein one and the other strips are oriented in a manner such that, one, the front or rear differential housing is positioned between the front or rear driver and passenger reverse power couplers and on the longitudinal line with the flexible joint flanges being aligned with the input shafts of the front or rear driver and passenger reverse power couplers, respectively, the alignment referring to the flexible joint flanges occupying a line passing through the input shafts and two, an open space is created between the strips such that the underlying upper and lower leading links and long axle shaft can travel upward between the strips and into the frame side aperture when the suspension compresses;
wherein the driver and passenger differential housing mounting brackets are attached to the driver and passenger sides of the front or rear differential housing such that: the cooperative effect of the two flat plates being attached to the driver and passenger sides of the front differential housing and of the second ends of each strip in one and the other strips being attached to the driver and passenger frame sides results in the driver and passenger differential housing mounting brackets securing the front differential housing to the front end of the frame, while the cooperative effect of the two flat plates being attached to the driver and passenger sides of the rear differential housing and of the second ends of each strip in one and the other strips being attached to the driver and passenger frame sides results in the driver and passenger differential housing mounting brackets securing the rear differential housing to the rear end of the frame, respectively.

5. The drivetrain of claim 1 or 2 wherein the front or rear driver and passenger reverse power couplers cooperatively interact with the front or rear independent suspension system, the front or rear independent suspension system possesses a configuration that includes driver and passenger upper and lower leading links and driver and passenger upper and lower trailing links each link has a first and second ends, respectively;
wherein the front driver or passenger upper and lower leading links extend laterally from the front passenger or driver reverse power coupler to a front driver or passenger knuckle, respectively; wherein the front driver or passenger upper and lower trailing links extend longitudinally from a point near the middle of the driver or passenger frame side to the front driver or passenger knuckle, respectively the front knuckle being steerable; wherein the rear driver or passenger upper and lower leading links extend laterally from the rear passenger or driver reverse power coupler to a rear driver or passenger knuckle, respectively; wherein the rear driver or passenger upper and lower trailing links extends longitudinally from a point near the middle of the driver or passenger frame side to the rear driver or passenger knuckle, respectively, the rear knuckle being non-steerable;
wherein the first end of the front driver or passenger upper leading link is affixed to a flexible joint, the flexible joint is pivotally attached to a mounting bracket, the mounting bracket is affixed to a middle of the front passenger or driver reverse power coupler above the output shaft, and the first end of the front driver or passenger lower leading link is affixed to a flexible joint, the flexible joint is pivotally attached to a mounting bracket, the mounting bracket is affixed to a bottom of the front passenger or driver reverse power coupler below the output shaft, respectively, each shaft and mounting bracket projecting inward towards the engine bay; wherein the first ends of the front driver or passenger upper and lower trailing links are affixed to flexible joints, the flexible joints are pivotally attached to mounting brackets, the mounting brackets are vertically affixed to a top and bottom of the driver or passenger frame side near its mid-point, respectively, each mounting bracket projecting outward away from the engine bay; wherein the second ends of the front driver or passenger upper leading and trailing links are attached to an upper apex bracket while the second ends of the front driver or passenger lower leading and trailing links are attached to a lower apex bracket, respectively; wherein the upper and lower apex brackets each contain a ball joint, the ball joints being pivotally attached to a top and bottom of the driver or passenger steering or knuckle, respectively
wherein the first end of the rear driver or passenger upper heading link is affixed to a flexible joint, the flexible joint is pivotally attached to a mounting bracket, mounting bracket is affixed to a middle of the rear passenger or driver reverse power coupler above the output shaft, and the first end of the rear driver passenger tower leading link is affixed to a flexible joint, the flexible joint is pivotally attached to a mounting bracket, the mounting bracket is affixed to a bottom of the rear passenger or driver reverse power coupler below the output shaft, respectively, each shaft and mounting brackets projecting inward towards the engine bay; wherein the first ends of the rear driver or passenger upper and lower trailing links are affixed to flexible joints, the flexible joints are pivotally attached to mounting brackets, the mounting brackets are vertically affixed to the top and bottom of the driver or passenger frame side near its mid-point, respectively, each mounting bracket projecting outward away from the engine bay; wherein the second ends of the rear driver or passenger upper leading and trailing links are attached to the upper apex bracket while the second ends of the rear driver or passenger lower leading and trailing links are attached to the lower apex bracket, respectively; wherein the upper and lower apex brackets each contain a ball joint, the ball joints being pivotally attached to a top and bottom of the driver or passenger non-steering knuckle, respectively.

6. (canceled)

7. The drivetrain of claim 1 wherein a front drivetrain includes the front differential housing, front driver and passenger reverse power couplers, front driver and passenger short axle shafts, and front driver and passenger long axle shafts, respectively;
wherein the front driver short axle shaft has a first and second ends, each end is affixed to a flexible joint such that the flexible joint on the first end is pivotally attached to the flexible joint flange on the driver side of the front differential housing and that on the second end is pivotally attached to the input shaft of the front driver reverse power coupler; wherein the front driver long axle shaft has a first and second ends, each end is affixed to a flexible joint such that the flexible joint on the first end is pivotally attached to the output shaft of the front passenger reverse power coupler and that on the second end is pivotally attached to a front driver wheel hub; wherein the front driver wheel hub has a first and second sides such that one side is rotatably attached to the driver steering knuckle and the other side is attached to the front driver wheel;
wherein the front passenger short axle shaft has a first and second ends, each end is affixed to a flexible joint such that the flexible joint on the first end is pivotally attached to the flexible joint flange on the passenger side of the front differential housing and that on the second end is pivotally attached to the input shaft of the front passenger reverse power coupler; wherein the front passenger long axle shaft has a first and second ends, each end is affixed to a flexible joint such that the flexible joint on the first end is pivotally attached to the output shaft of the front driver reverse power coupler and that on the second end is pivotally attached to a front passenger wheel hub; wherein the front passenger wheel hub has a first and second sides such that one side is rotatably attached to the passenger steering knuckle and the other side is attached to the front passenger wheel.

8. The drivetrain of claim 1 wherein a rear drivetrain includes the rear differential housing, rear driver and passenger reverse power couplers, rear driver and passenger short axle shafts, and rear driver and passenger long axle shafts, respectively;
wherein the rear driver short axle shaft has a first and second ends, each end is affixed to a flexible joint such that the flexible joint on the first end is pivotally attached to the flexible joint flange on the driver side of the rear differential housing and that on the second end is pivotally attached to the input shaft of the rear driver reverse power coupler; wherein the rear driver long axle shaft has a first and second ends, each end is affixed to a flexible joint such that the flexible joint on the first end is pivotally attached to the output shaft of the rear passenger reverse power coupler and that on the second end is pivotally attached to a rear driver wheel hub; wherein the rear driver wheel hub has a first and second sides such that one side is rotatably attached to the driver non-steering knuckle and the other side is attached to the rear driver wheel;
wherein the rear passenger short axle shaft has a first and second ends, each end is affixed to a flexible joint such that the flexible joint on the first end is pivotally attached to the flexible joint flange on the passenger side of the rear differential housing and that on the second end is pivotally attached to the input shaft of the rear passenger reverse power coupler; wherein the rear passenger long axle shaft has a first and second ends, each end is affixed to a flexible joint such that the flexible joint on the first end is pivotally attached to the output shaft of the rear driver reverse power coupler and that on the second end is pivotally attached to a rear passenger wheel hub; wherein the rear passenger wheel hub has a first and second sides such that one side is rotatably attached to the passenger non-steering knuckle and the other side is attached to the rear passenger wheel.

9. The drivetrain of claim 1; wherein power is transmitted from the engine to the transmission and then from the transmission to the transfer case in a manner typical in the art;
wherein the front drive shaft has a front and rear ends, each end is affixed to a flexible joint such that the flexible joint on the front end is pivotally attached to the input shaft of the offset power coupler and that on the rear end is pivotally attached to the first output shaft of the transfer case pivotal attachments enable power to be transmitted from the transfer case to the offset power coupler; wherein the rear drive shaft has a front and rear ends, each end is affixed to a flexible joint such that the flexible joint on the front end is pivotally attached to the second output shaft of the transfer case and that on the rear end is pivotally attached to the pinion shaft of the rear differential housing the pivotal attachments enable power to be transmitted from the transfer case to the rear differential housing.

10. (canceled)

11. The drivetrain of claim 3, 7, or 8 wherein power is able to be transmitted from the offset power coupler to the front differential housing due to the output shaft of the offset power coupler being adapted to the pinion shaft of the front differential housing;
wherein power is able to be transmitted from the front differential housing to the front driver and passenger reverse power couplers due to the combined effects of the first ends of the front driver and passenger short axle shafts being pivotally attached to the flexible joint flanges on the driver and passenger sides of the front differential housing and of the second ends of the front driver and passenger short axle shafts being pivotally attached to the input shafts of the front driver and passenger reverse power couplers, respectively; wherein power is able to be transmitted from the front driver and passenger reverse power couplers to the front passenger and driver wheel hubs due to the combined effects of the first ends of the front passenger and driver long axle shafts being pivotally attached to the output shafts of the front driver and passenger reverse power couplers and of the second ends of the front passenger and driver long axle shafts being pivotally attached to the front passenger and driver wheel hubs, respectively;
wherein power is able to be transmitted from the rear differential housing to the rear driver and passenger reverse power couplers due to the combined effects of the first ends of the rear driver and passenger short axle shafts being pivotally attached to the flexible joint flanges on the driver and passenger sides of the rear differential housing and of the second ends of the rear driver and passenger short axle shafts being pivotally attached to the input shafts of the rear driver and passenger reverse power couplers, respectively; wherein power is able to be transmitted from the rear driver and passenger reverse power couplers to the rear passenger and driver wheel hubs due to the combined effects of the first ends of the rear passenger and driver long axle shafts being pivotally attached to the output shafts of the rear driver and passenger reverse power couplers and of the second ends of the rear passenger and driver long axle shafts being pivotally attached to the rear passenger and driver wheel hubs, respectively.
